(19) United States
(12) Patent Application Publication
(10) Pub. No.: US 2019/0223641 A1
(43) Pub. Date: Jul. 25, 2019

(54) Utensils for Stacking

(71) Applicant: GPCP IP Holdings LLC, Atlanta, GA (US)

(72) Inventor: Shawn Allen Oakes, Ripon, WI (US)

(21) Appl. No.: 16/226,915

(22) Filed: Dec. 20, 2018

Related U.S. Application Data
(60) Provisional application No. 62/621,532, filed on Jan. 24, 2018.

(51) Int. Cl. A47G 21/02; A47G 21/04; B26B 9/02

(52) U.S. Cl. CPC A47G 21/02; B26B 9/02; A47G 21/04; A47G 21/023

(57) ABSTRACT

A cutlery utensil that include a functional section and a handle. The handle can include a raised spine disposed on a first surface of the handle and having a height that varies from a first end of the handle in the direction of the functional section. At least one recessed channel can be formed in a second surface of the utensil, the second surface of the utensil being opposite the first surface of the utensil, wherein the recessed channel has a depth that varies from the first end of the handle in the direction of the functional section.

### CROSS REFERENCE TO RELATED APPLICATIONS

This application claims priority to U.S. Application No. 62/621,532, filed Jan. 24, 2018, and entitled “UTENSILS FOR STACKING”, which is hereby incorporated by reference in its entirety.

### BACKGROUND

### Field

The present disclosure relates to disposable cutlery. More particularly, the present disclosure relates to utensils configured to be stacked and reliably dispensed from a dispenser one at a time.

### Description of the Related Art

Disposable utensils can typically be found in fast-food and take out restaurants. Such restaurants allow consumers the ability to select various types of utensils that they wish to use by taking the utensils from a publicly accessible dispenser or bin. Conventional utensil dispensers have been used to provide a confined and controlled protective environment for utensils housed within. Such assemblies, however, have challenges and issues delivering utensils to a consumer in a repeatable and reliable manner. Conventional assemblies can also have difficulties associated with loading utensils and with maintaining a reliable supply of utensils for customers.

There is a need, therefore, for a cutlery dispenser that can supply utensils to customers in a reliable and sanitary manner. In addition, it may be desirable to provide utensils that are not prone to flipping or otherwise changing from a desired orientation during shipping, the process of being loaded into a dispenser, or a process of being dispensed from a dispenser. For example, during dispensing of a stack of loose utensils, the utensils may have a tendency to flip or rotate within the dispenser as the stack slides within the dispenser, which may lead to jamming the dispenser, thereby potentially compromising the utility of the dispenser.

Additionally, it may be desirable to provide utensils in a form that are capable of being reliably dispensed from a dispenser one at a time. Utensils that are loosely received in a dispenser may have a tendency to dispense such that more than one utensil is unintentionally dispensed by a patron. This results in defeating one of the potential advantages of dispensing utensils via a dispenser—reducing costs associated with patrons taking more utensils than necessary.

### SUMMARY

A cutlery utensil and stack of same are provided. Each utensil includes a functional section and a handle. The handle can include a raised spine disposed on a first surface of the handle and having a height that varies from a first end of the handle in the direction of the functional section. At least one recessed channel can be formed in a second surface of the utensil, the second surface of the utensil being opposite the first surface of the utensil, wherein the recessed channel has a depth that varies from the first end of the handle in the direction of the functional section. In other embodiments, the handle can include a raised spine disposed on a first surface of the handle having a height that increases from a first end of the raised spine to a second end of the raised spine in the direction of the functional section, a first recessed channel formed in a second surface of the handle. The first surface is opposite the second surface. A second recessed surface can be formed within the first recessed channel, wherein the recessed channels are configured to receive a raised spine of a second utensil. In other embodiments, the functional section can include at least one detent extending laterally from a side thereof.

### BRIEF DESCRIPTION OF THE DRAWINGS

FIG. 1 depicts a top perspective view of an illustrative spoon, according to one or more embodiments described herein.

FIG. 2 depicts a top perspective view of an illustrative fork, according to one or more embodiments described herein.

FIG. 3 depicts a top perspective view of an illustrative knife, according to one or more embodiments described herein.

FIG. 4 depicts a top view of the spoon of FIG. 1, according to one or more embodiments described herein.

FIG. 5 depicts a bottom view of the spoon of FIG. 1, according to one or more embodiments described herein.

FIG. 6 depicts a bottom perspective view of the fork of FIG. 1, according to one or more embodiments described herein.

FIG. 7 depicts a side view of the fork of FIG. 1, according to one or more embodiments described herein.

FIG. 8a depicts a side view of an illustrative stack of forks, according to one or more embodiments described herein.

FIG. 8b depicts a cross-section view taken through AA of FIG. 8a of an illustrative stack of forks, according to one or more embodiments described herein.

FIG. 8c depicts an enlarged view of the circled portion B of FIG. 8c of an illustrative stack of forks, according to one or more embodiments described herein.

FIG. 8d depicts a top perspective view of an illustrative stack of forks, according to one or more embodiments described herein.

FIG. 9 depicts a bottom perspective view of the knife of FIG. 2, according to one or more embodiments described herein.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure. The figures are not necessarily to scale and certain features and certain views of the figures may be shown exaggerated in scale or in schematic for clarity and/or conciseness

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

The terms “up” and “down”; “upward” and “downward”; “upper” and “lower”; “upwardly” and “downwardly”; “above” and “below”; and other like terms as used herein refer to relative positions to one another and are not intended to denote a particular spatial orientation since the apparatus and methods of using the same may be equally effective at various angles or orientations.

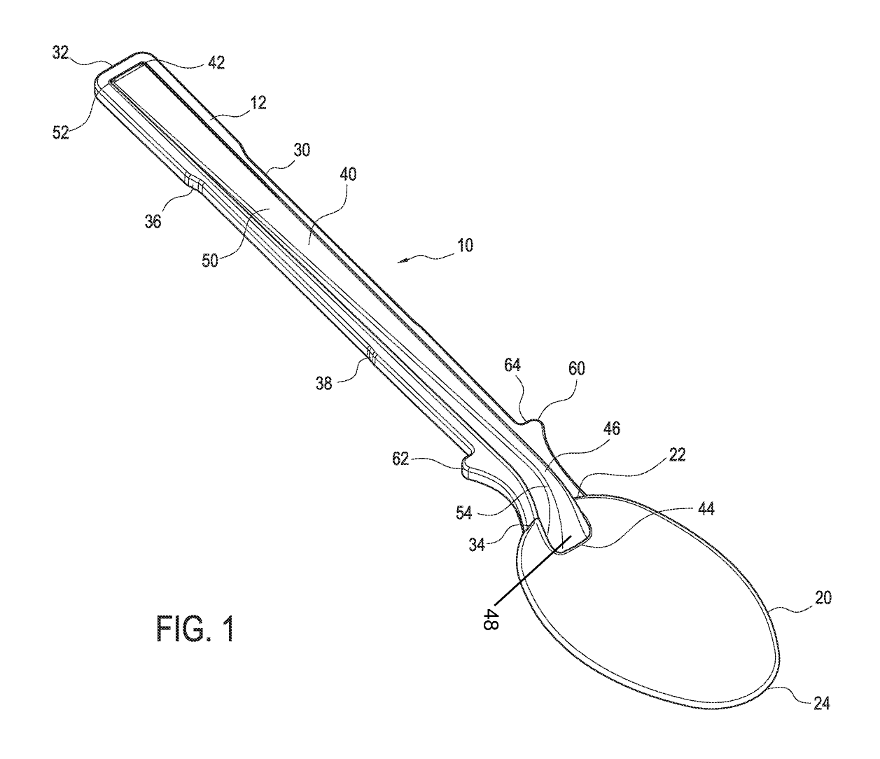

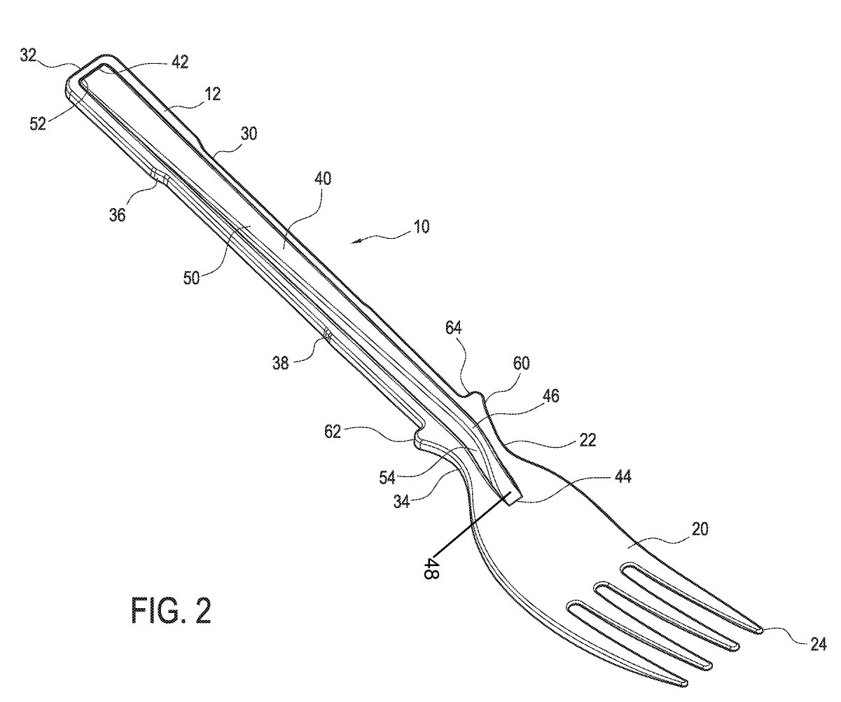

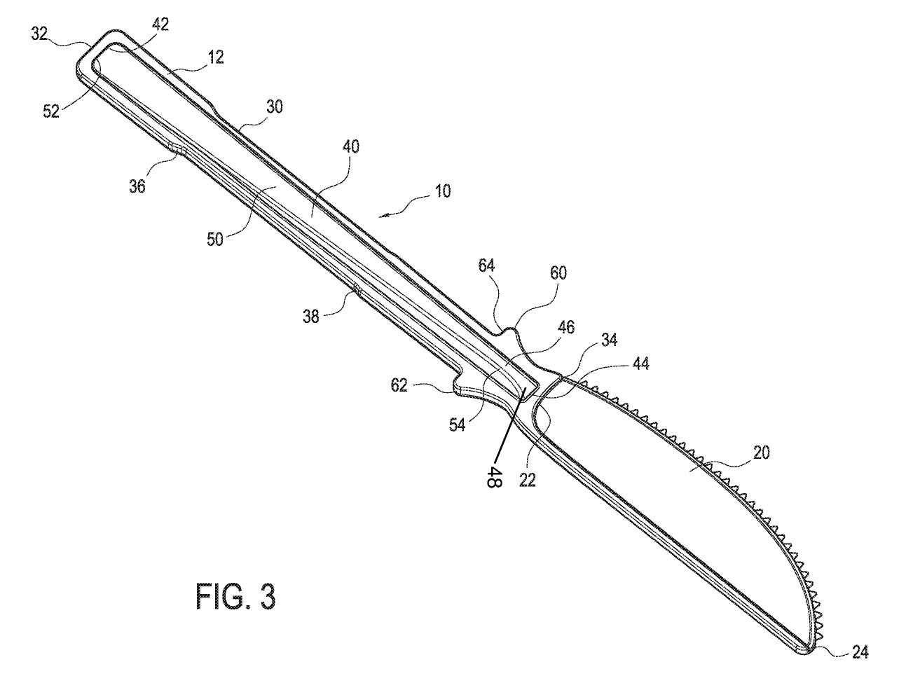

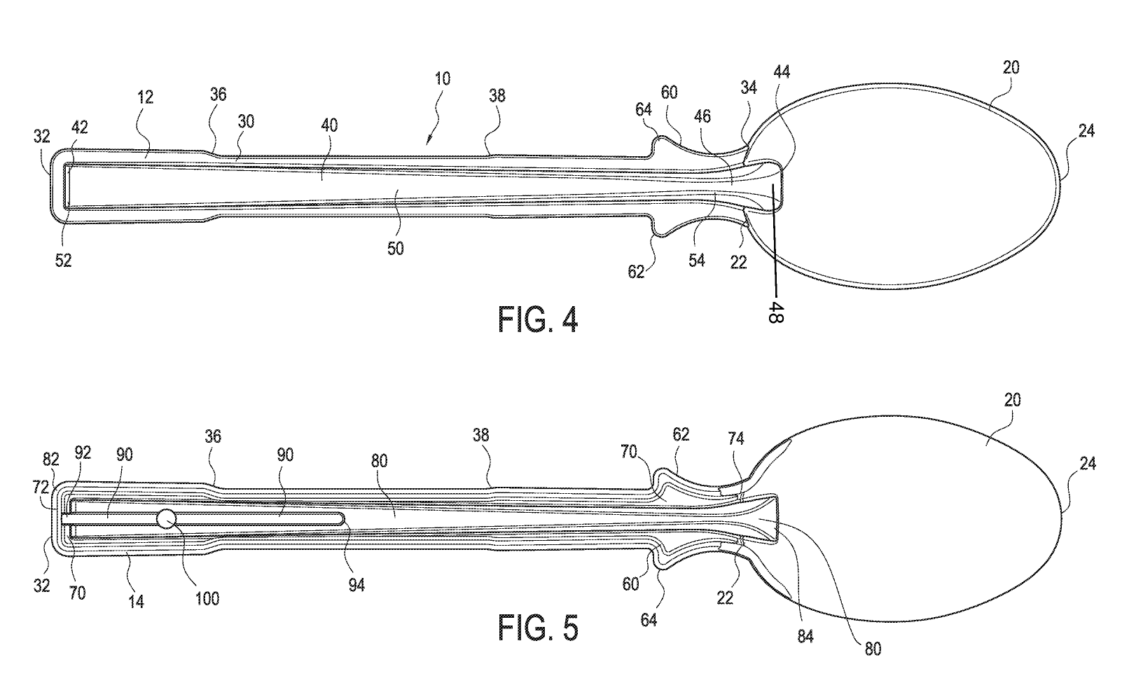

A utensil or piece of cutlery having one or more stacking features in combination with one or more dispenser adapters is provided. The utensil can be any shape or form and can be, for example, a spoon, fork, knife, spork, or the like. FIG. 1 depicts a perspective view of an illustrative utensil 10 in the shape of a spoon. FIG. 2 depicts a perspective view of an illustrative utensil 10 in the shape of a fork. FIG. 3 depicts a perspective view of an illustrative utensil 10 in the shape of a knife. FIG. 4 depicts a perspective view of an illustrative utensil 10 in the shape of a spoon. Each utensil 10 can be disposable and constructed from a formable material. The formable material can include, for example, plastic, combinations of plastics, or combinations of plastics and other materials suitable for use as disposable or reusable cutlery. In certain embodiments, the formable material can be or include polystyrene, polyethylene, polypropylene, as well as blends and mixtures thereof.

Referring to FIGS. 1 to 4, each utensil 10 can have a functional portion or section 20 adjacent and adjoining a handle 30. The functional section 20 can be configured to perform a function that assists in the consumption of food, such as for example, cutting, piercing, and/or scooping. The functional section 20 can have a first end 22 that is adjacent to the handle 30, and a second end 24 that is distal from the handle 30. The handle 30 can be utilized by a user to hold and/or manipulate the utensil 10. The handle 30 can have a first end 32 and a second end 34. For sake of reference, the first end 32 of the handle 30 can be the end furthest from the functional section 20, and the second end 34 can be the end adjacent and adjoining (i.e. closest) the functional section 20.

Each utensil 10 can include an axially oriented protrusion or raised spine 40 extending outwardly and away from a first or upper surface 12 of the utensil 10. The raised spine 40 can form a raised portion of the handle 30 and/or the functional section 20. The raised spine 40 can extend from the first end 32 of the handle 30 to the second end 34 of the handle 30. The raised spine 40 can also extend into the functional section 20. The raised spine 40 can be continuous from its first end 42 to its second end 44, or the raised spine 40 can be intermittent (i.e. non-continuous). In one embodiment, the first end 42 of the raised spine 40 can be proximate the handle 30, and the second end 44 of the raised spine 40 can be proximate the functional section 20.

The length of the raised spine 40 can extend over the entire length of the handle 30, or any portion thereof. For example, the length of the raised spine 40 can be about 10%, about 20%, about 30% or more of the length of the handle 30. The length of the raised spine 40 also can be about 70%, about 80%, about 90% or more of the length of the handle 30. The length of the raised spine 40 also can range from a low of about 15%, about 25%, or about 35% to a high of about 85%, about 95%, about 105%, or about 155% of the length of the handle 30. The length of the raised spine 40 as measured from its first end 42 to its second end 44 can be at least 1 cm, at least 2 cm, at least 3 cm, at least 4 cm, at least 5 cm, between 0.5 and 5 cm, between 0.5 and 4 cm, between 0.5 and 3 cm, between 0.5 and 2 cm, between 1 and 5 cm, between 1 and 4 cm, between 1 and 3 cm, between 1 and 2 cm, between 2 and 5 cm, between 2 and 4 cm, or between 2 and 3 cm.

The raised spine 40 can have a height that varies from its first end 42 to its second end 44. The height of the raised spine 40 can increase or slant from its first end 42 to its second end 44, i.e., in the direction toward the functional section 20. The height of the raised spine 40 can decrease or slant from its first end 42 to its second end 44, i.e., in the direction toward the functional section 20. The changes in the height of the raised spine 40 from the first end 42 to its second end 44 can be gradual or the changes can occur intermittently at different points along the raised spine 40. The highest point or portion of the raised spine 40 is its crown 46. The crown 46 can be proximate or adjacent to the second end 34 of the handle 30 or the first end 22 of the functional section 20 or be proximate or adjacent to the first end 34 of the handle 30 or any other suitable location along the utensil. The spine crown 46 can have a height measured from the first surface 12 to the top of the spine crown 46 that is greater than 0.1 cm, greater than 0.2 cm, greater than 0.3 cm, greater than 0.4 cm, greater than 0.5 cm, less than 0.5 cm, less than 0.4 cm, less than 0.3 cm, less than 0.2 cm, between 0.1 cm and 0.5 cm, between 0.1 cm and 0.4 cm, between 0.1 cm and 0.3 cm, between 0.1 cm and 0.2 cm, between 0.2 cm and 0.5 cm, between 0.2 cm and 0.4 cm, between 0.2 cm and 0.3 cm, or between 0.3 cm and 0.5 cm.

The raised spine 40 can have a width that varies between its first end 42 and its second end 44. The width of the raised spine 40 can decrease from its first end 42 towards its second end 44, i.e. in the direction from the handle 30 toward the functional section 20. The width of the raised spine 40 also can increase in the direction from the handle 30 toward the functional section 20. In certain embodiments, the widest portion of the raised spine 40 is at the spine crown 46. The raised spine 40 can have a maximum width that is greater than 0.1 cm, greater than 0.2 cm, greater than 0.3 cm, greater than 0.4 cm, greater than 0.5 cm, between 0.1 and 0.5 cm, less than 1.5 cm, less than 1.0 cm, less than 0.8 cm, less than 0.6 cm, between 0.1 and 1.0 cm, between 0.1 cm and 0.8 cm, between 0.1 cm and 0.6 cm, between 0.2 cm and 1.0 cm, between 0.2 cm and 0.8 cm, between 0.2 cm and 0.6 cm, or between 0.3 cm and 1.0 cm. The maximum width of the raised spine 40 can be proximate or adjacent the first end 42 of the raised spine 40. The width of the raised spine 40 at its first end 42 can be greater than about 50%, about 60%, about 70%, about 80%, about 90%, or about 95% of the width of the handle 30. The width of the raised spine 40 at its second end 44 can be greater than about 55%, about 65%, about 75%, about 85%, about 95%, or about 98% of the width of the handle 30.

The raised spine 40 can have a minimum width that is less than 0.5 cm, less than 0.4 cm, less than 0.3 cm, less than 0.2 cm, less than 0.1 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm. The minimum width of the raised spine 40 on the handle 30 can be at the spine crown 46. The width of the raised spine 40 at the spine crown 46 can be less than 50% of the width of the handle 30 at the raised spine crown 46, less than 40% of the width of the handle 30 at the raised spine crown 46, less than 30% of the width of the handle 30 at the raised spine crown 46, less than 20% of the width of the handle 30 at raised spine crown 46, less than 10% of the width of the handle 30 at raised spine crown 46.

The raised spine 40 can have a varying height along a first section 50 that can increase in the direction of the functional section 20. The first section 50 can have a first section end 52 that is relatively closer to the raised spine first end 42 and a second section end 54 that is relatively closer to the raised spine second end 44. The first section end 52 can be adjacent to the raised spine first end 42 or any suitable position along the length of the raised spine 40 where the raised spine begins to increase in height. The second section end 54 can be adjacent to the spine crown 46 or anywhere the raised spine 40 begins to decrease in height. The length of the first section 50 as measured from the first section end 52 to the second section end 54 can be at least 1 cm, at least 2 cm, at least 3 cm, at least 4 cm, at least 5 cm, at least 6 cm, at least 7 cm, at least 8 cm, at least 9 cm, at least 10 cm, less than 15 cm, less than 14 cm, less than 13 cm, less than 12 cm, less than 10 cm, less than 8 cm, between 0.5 and 15 cm, between 0.5 and 10 cm, between 0.5 and 8 cm, between 0.5 and 6 cm, between 1 and 55 cm, between 1 and 10 cm, between 1 and 8 cm, between 1 and 6 cm, between 2 and 15 cm, between 2 and 10 cm, or between 2 and 8 cm. The length of the first section can be greater than 50% of the length of the raised spine 40, greater than 70% of the length of the raised spine 40, greater than 80% of the length of the raised spine 40, greater than 90% of the length of the raised spine 40, greater than 95% of the length of the raised spine 40.

Utensil 10 can include at least one shaped extension 60 that is disposed on one or both sides of the utensil 10. The shaped extension 60 can be a wing, detent, or other shape protruding from the side of the utensil 10. The shaped extension 60 can extend laterally from a side of the functional section 20 or the side of the handle 30. The shaped extension 60 can be disposed on any suitable position along the length of the utensil 10. The shaped extension 60 can be disposed proximate the crown 46 of the raised spine 40. In certain embodiments, the shaped extension 60 can be two laterally opposed shaped extensions 62, 64. A first shaped extension 62 can laterally extending from a first lateral side of the utensil 10 (e.g. from the handle 30 or the functional section 20), and a second shaped extension 64 laterally extending from an opposite of the utensil 10 (e.g. from the handle 30 or functional section 20). The first and second shaped extensions 60 can be co-planar. Each shaped extension 60 can have any shape or cross-section, including for example, wing-shaped, triangular, rectangular, square, hexagonal, pentagonal, or any other shape capable of forming a surface. If two or more shaped extensions 60 are used, the shape or cross-section of each shaped extension 60 can be the same or different. In certain embodiments, there could be multiple shaped extensions (not shown) on one side of the utensil 10 or on both sides of the utensil 10.

The handle 30 can be chamfered, tapered, or profiled anywhere along its length. For example, the first end 32 of the handle 30 can be chamfered, tapered, or profiled. The chamfer at the first end 32 can make it easier for the dispensing unit to pick between utensils 10 when stacked. In some embodiments, a portion of each handle 30 can be cutout to provide a thinner section or profile. Similar to a chamfer, this cutout in the handle 30 can make it easier for a dispensing unit (not shown) to pick between utensils 10.

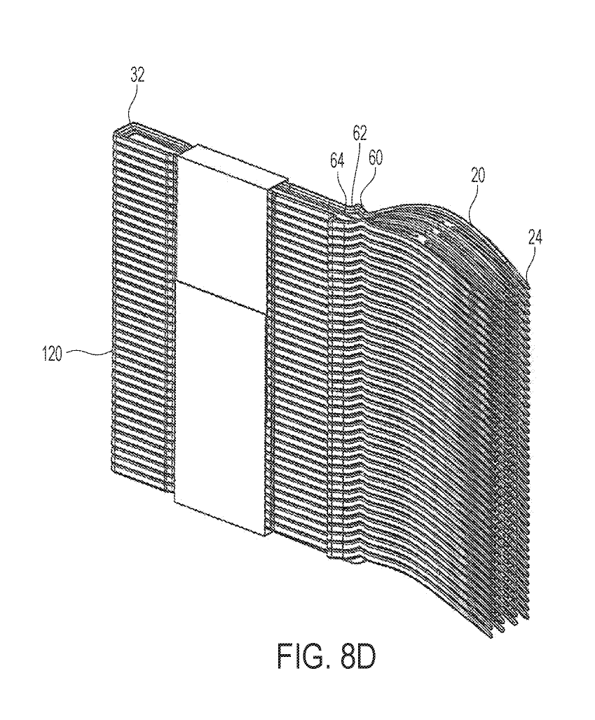

Still referring to FIGS. 1-4, as the utensils 10 can be stacked in a dispense chassis, one or more nesting features can be used to stabilize a stack 120 of utensils 10. The handle 30 can have one or more cutouts disposed along a length thereof for receiving a band 110 (shown in FIG. 8) to help the utensils 10 remain in a stacked orientation. For example, a cutout section can be formed in the handle 30 between a first shoulder or cutout 36 and the shaped extension 60. In another example, a cutout section can be formed in the handle 30 between the first cutout 36 and a second shoulder or cutout 38. The length of the cutout as measured from the first cutout 36 to the second cutout 38 can be greater than 1 cm, greater than 2 cm, greater than 3 cm, greater than 4 cm, less than 10 cm, less than 8 cm, less than 6 cm, between 1 and 10 cm, between 1 and 8 cm, between 1 and 6 cm, between 2 and 10 cm, between 2 and 8 cm, between 2 and 6 cm. The width of the band 110 can be about the same length as the length of the cutout. Additionally, one or both sides of the handle 30 can taper from the first cutout 36 toward the first handle end 32. The taper can make the band 110 tighten as the band 110 is moved from the first cutout 36 toward the first handle end 32. One or both sides of the handle 30 can taper from the second cutout 38 toward the second handle end 34. The taper can make the band 110 tighten as the band 110 is moved from the second cutout 38 toward the second handle end 34. Any tapers on the handle 30 can be continuous or intermittent. The band 110 can be removed prior to or after the utensils 10 are loaded in a dispenser. In one embodiment, the band 110 can be absent of adhesive that contacts the utensils 10. In a separate embodiment, the band 110 can contain adhesive that contacts the utensils 10.

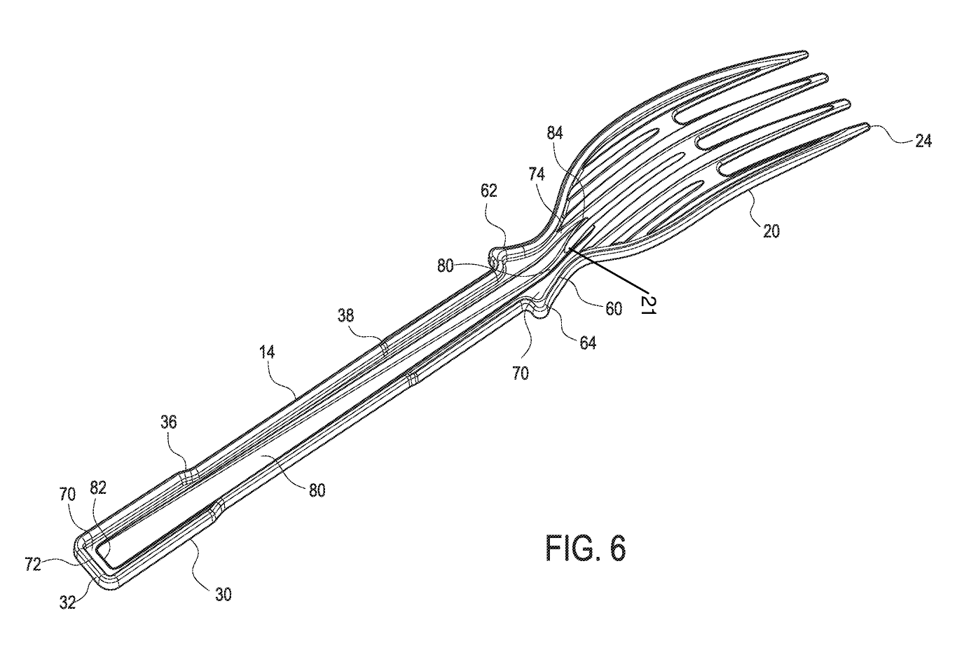

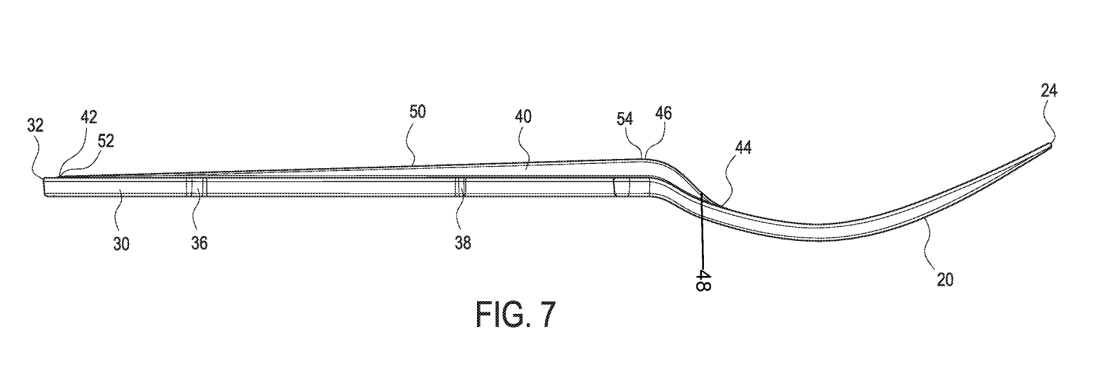

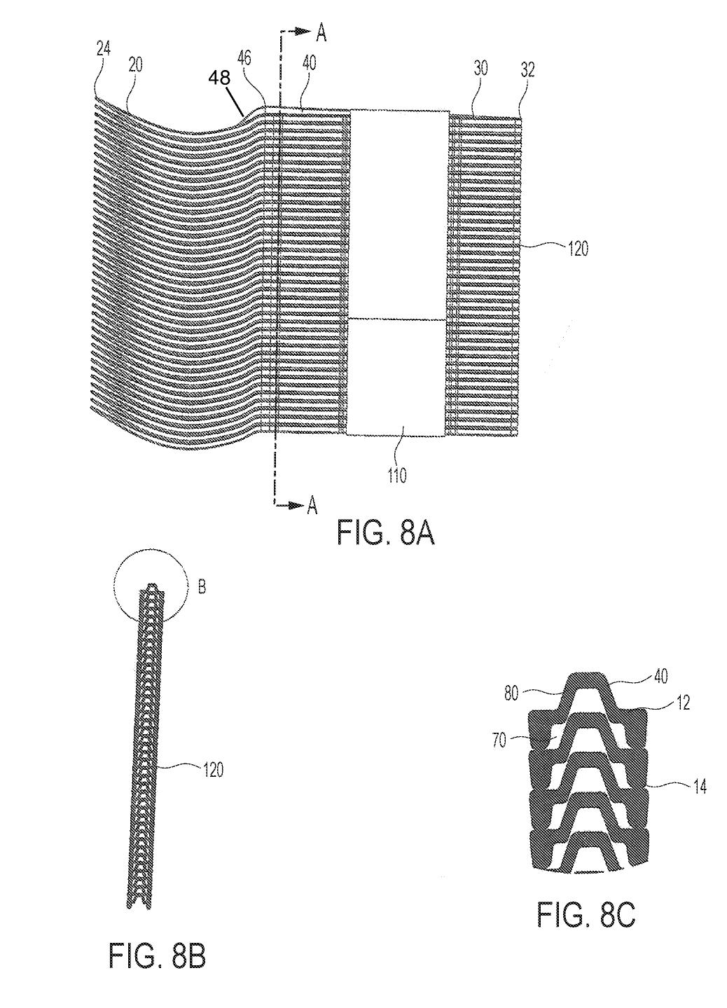

FIG. 5 depicts a bottom view of the spoon of FIG. 1, and FIG. 6 depicts a bottom perspective view of the fork of FIG. 1, according to one or more embodiments. As seen in these bottom perspective views, the utensil 10 can have a second or bottom surface 14 that is opposite the upper or top surface 12. One or more channels or recessed groves 70, 80 (two are shown) can be formed in the second surface 14. Each recessed channel 70, 80 can extend along a portion, or all, of the second surface 14. As depicted, a first recessed channel 70 can be formed in the second surface 14 and a second recessed channel 80 can be formed within the first recessed channel 70. The maximum depth of the first recessed channel 70 or the second recessed channel 80 can be substantially equal to a maximum height of the raised spine 40.

First recessed channel 70 can have a first recessed channel first end 72 that can be adjacent to the first handle end 32. The first recessed channel first end 72 can be less than 0.5 cm, less than 0.4 cm, less than 0.3 cm, less than 0.2 cm, or less than 0.1 cm from the first handle end 32. First recessed channel 70 can have a first recessed channel second end 74 that can be on either the handle 30 or on the functional section 20. The first recessed channel second end 74 can be adjacent to either the first functional section end 22 or second handle end 34. The first recessed channel second end 74 can be less than 0.5 cm, less than 0.4 cm, less than 0.3 cm, less than 0.2 cm, or less than 0.1 cm from the first functional section end 22. The first recessed channel second end 74 can be less than 0.5 cm, less than 0.4 cm, less than 0.3 cm, less than 0.2 cm, or less than 0.1 cm from the second handle end 34.

The length of the first recessed channel 70 as measured from the first recessed channel first end 72 to the first recessed channel second end 74 can be at least 1 cm, at least 2 cm, at least 3 cm, at least 4 cm, at least 5 cm, at least 6 cm, at least 7 cm, at least 8 cm, at least 9 cm, at least 10 cm, less than 15 cm, less than 14 cm, less than 13 cm, less than 12 cm, less than 10 cm, less than 8 cm, between 0.5 and 15 cm, between 0.5 and 10 cm, between 0.5 and 8 cm, between 0.5 and 6 cm, between 1 and 15 cm, between 1 and 10 cm, between 1 and 8 cm, between 1 and 6 cm, between 2 and 15 cm, between 2 and 10 cm, or between 2 and 8 mm. The length of the first recessed channel 70 can be substantially the same length as the raised spine 40. The length of the first recessed channel 70 can be at least 1 cm, at least 2 cm, at least 3 cm, at least 4 cm, at least 5 cm, between 0.5 and 5 cm, between 0.5 and 4 cm, between 0.5 and 3 cm, between 0.5 and 2 cm, between 1 and 5 cm, between 1 and 4 cm, between 1 and 3 cm, between 1 and 2 cm, between 2 and 5 cm, between 2 and 4 cm, or between 2 and 3 cm longer than the length of the raised spine 40.

The first recessed channel 70 can have a constant depth or varying depth that can increase in depth in the direction of the functional section 20 until reaching a maximum depth. The maximum depth of the first recessed channel 70 can be adjacent to the second handle end 34 or the first functional section end 32. The first recessed channel 70 can have a depth measured from the second surface 14 to the bottom of the first recessed channel 70 that is greater than 0.1 cm, greater than 0.2 cm, greater than 0.3 cm, greater than 0.4 cm, greater than 0.5 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm.

The first recessed channel 70 can have a fairly constant width, a varying width that can decrease in width in the direction of the functional section 20 until reaching a minimum width, or can increase in width in the direction of the functional section 20 until reaching a maximum width or other suitable configuration. The first recessed channel 70 can have a maximum width that is greater than 0.1 cm, greater than 0.2 cm, greater than 0.3 cm, greater than 0.4 cm, greater than 0.5 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm. The maximum width of the first recessed channel 70 can be at the first recessed channel first end 72. The width of the first recessed channel 70 at first recessed channel first end 72 can be greater than 50% of the width of the handle 30 at first recessed channel first end 72, greater than 70% of the width of the handle 30 first recessed channel first end 72, greater than 80% of the width of the handle 30 at the first recessed channel first end 72, greater than 90% of the width of the handle 30 at the first recessed channel first end 72, greater than 95% of the width of the handle 30 at the first recessed channel first end 72.

The first recessed channel 70 can have a minimum width that is less than 0.5 cm, less than 0.4 cm, less than 0.3 cm, less than 0.2 cm, less than 0.1 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm. The minimum width of the first recessed channel 70 can be adjacent to the shaped extension(s) 60. The minimum width of the first recessed channel 70 can be less than 50% of the width of the handle 30 at the minimum width of the first recessed channel 70, less than 40% of the width of the handle 30 at the minimum width of the first recessed channel 70, less than 30% of the width of the handle 30 at the minimum width of the first recessed channel 70, less than 20% of the width of the handle 30 at the minimum width of the first recessed channel 70, less than 10% of the width of the handle 30 at the minimum width of the first recessed channel 70. The first channel 70 can receive a raised spine 40 of an adjacent utensil in a stack of utensils 120. The raised spine 40 of the second utensil can nest within the first channel 70. This nesting of raised spine 40 within the first channel 70 of another adjacent utensil and can increase the stability of a stack of utensils 120 without increasing the height of the stack of utensils 120.

Second recessed channel 80 can have a second recessed channel first end 82. The second recessed channel first end 82 can be adjacent to the first handle end 32. The second recessed channel first end 82 can be less than 0.5 cm, less than 0.4 cm, less than 0.3 cm, less than 0.2 cm, or less than 0.1 cm from the first handle end 32. Second recessed channel 80 can have a second recessed channel second end 84 that can be on either the handle 30 or on the functional section 20. The second recessed channel second end 84 can be adjacent to either the first functional section end 22 or second handle end 34. The second recessed channel second end 84 can be less than 0.5 cm, less than 0.4 cm, less than 0.3 cm, less than 0.2 cm, or less than 0.1 cm from the first functional section end 22. The second recessed channel second end 84 can be less than 0.5 cm, less than 0.4 cm, less than 0.3 cm, less than 0.2 cm, or less than 0.1 cm from the second handle end 34.

The length of the second recessed channel 80 as measured from the second recessed channel first end 82 to the second recessed channel second end 84 can be at least 1 cm, at least 2 cm, at least 3 cm, at least 4 cm, at least 5 cm, between 0.5 and 5 cm, between 0.5 and 4 cm, between 0.5 and 3 cm, between 0.5 and 2 cm, between 1 and 5 cm, between 1 and 4 cm, between 1 and 3 cm, between 1 and 2 cm, between 2 and 5 cm, between 2 and 4 cm, or between 2 and 3 cm. The length of the second recessed channel 80 can be substantially the same length as the raised spine 40.

The second recessed channel 80 can have a varying depth that can increase in depth in the direction of the functional section 20 until reaching a maximum depth. The maximum depth of the second recessed channel 80 can be adjacent to the second handle end 34 or the first functional section end 32 or opposite the spine crown 46. The second recessed channel 80 can have a depth measured from the second surface 14 to the bottom of the second recessed channel 80 that is greater than 0.1 cm, greater than 0.2 cm, greater than 0.3 cm, greater than 0.4 cm, greater than 0.5 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm. The second recessed channel 80 can have a relative depth measured from the bottom of the first recessed channel 70 to the bottom of the second recessed channel 80 that is greater than 0.1 cm, greater than 0.2 cm, greater than 0.3 cm, greater than 0.4 cm, greater than 0.5 cm, less than 1.5 cm, less than 1.0 cm, less than 0.8 cm, less than 0.6 cm, between 0.1 and 1.5 cm, between 0.1 and 1.0 cm, between 0.1 and 0.8 cm, between 0.1 and 0.6 cm, between 0.2 and 1.5 cm, between 0.2 and 1.0 cm, between 0.2 and 0.8 cm, or between 0.3 and 0.6 cm.

The second recessed channel 80 can have a varying width that can decrease in width in the direction of the functional section 20 until reaching a minimum width. The second recessed channel 80 can have a maximum width that is greater than 0.1 cm, greater than 0.2 cm, greater than 0.3 cm, greater than 0.4 cm, greater than 0.5 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm. The maximum width of the second recessed channel 80 can be at the second recessed channel first end 82 or any suitable location. The width of the second recessed channel 80 at second recessed channel first end 82 can be greater than 50% of the width of the handle 30 at the second recessed channel first end 82, greater than 70% of the width of the handle 30 at the second recessed channel first end 82, greater than 80% of the width of the handle 30 at the second recessed channel first end 82, greater than 90% of the width of the handle 30 at the second recessed channel first end 82, greater than 95% of the width of the handle 30 at the second recessed channel first end 82.

The second recessed channel 80 can have a minimum width that is less than 0.5 cm, less than 0.4 cm, less than 0.3 cm, less than 0.2 cm, less than 0.1 cm, between 0.1 and 0.5 cm, between 0.1 and 0.4 cm, between 0.1 and 0.3 cm, between 0.1 and 0.2 cm, between 0.2 and 0.5 cm, between 0.2 and 0.4 cm, between 0.2 and 0.3 cm, or between 0.3 and 0.5 cm. The minimum width of the second recessed channel 80 can be adjacent to the shaped extension(s) 60. The minimum width of the second recessed channel 80 can be less than 50% of the width of the handle 30 at the minimum width of the second recessed channel 80, less than 40% of the width of the handle 30 at the minimum width of the second recessed channel 80, less than 30% of the width of the handle 30 at the minimum width of the second recessed channel 80, less than 20% of the width of the handle 30 at the minimum width of the second recessed channel 80, less than 10% of the width of the handle 30 at the minimum width of the second recessed channel 80. The second channel 80 can receive a raised spine 40 of an adjacent utensil in a stack of utensils 120. The raised spine 40 of the second utensil can nest within the second channel 80. This nesting of raised spine 40 within the second channel 70 of another adjacent utensil and can increase the stability of a stack of utensils 120 without increasing the height of the stack of utensils 120.

As seen in FIG. 5, the second recessed channel 80 can have at least one counterweight 90 protruding from the surface of the second recessed channel 80. The counterweight 90 can be adjacent to the handle end 32. The length of the counterweight 90 as measured from the counterweight first end 92 to the counterweight second end 94 can be at least 0.5 cm, at least 1 cm, at least 2 cm, at least 3 cm, at least 4 cm, at least 5 cm, between 0.5 and 5 cm, between 0.5 and 4 cm, between 0.5 and 3 cm, between 0.5 and 2 cm, between 1 and 5 cm, between 1 and 4 cm, between 1 and 3 cm, between 1 and 2 cm. The shape of the counterweight 90 can be a cube, cuboid, cylinder, triangular prism, sphere, cone, or any other shape that can serve the function of a counterweight. The post 100 can be part of the counterweight 90. The counterweight 90 can be disposed on the first recessed channel 70, the second recessed channel 80, or both the first recessed channel 70 and the second recessed channel 80. The counterweight 90 can help provide balance and stability to the utensil 10 during use by acting as a counterweight to objects on the functional section 20 or as a counterweight when the utensil 10 is in a dispenser. This counterweight 90 can make it easier to separate the utensils 10 using a utensil dispenser (not shown).

As shown in FIGS. 8a and 8b, the utensils 10 can be stacked together to form a stack of utensils 120. The stack of utensils 120 can have a reduced gap between the utensils 10. The gap at the first end of the handle 32 as measured by the distance of first surface 12 of the first utensil to the second surface 14 of the adjacent utensil in the stack of utensils 120 can be less than 1 mm, less than 0.5 mm, less than 0.4 mm, less than 0.3 mm, less than 0.2 mm, or less than 0.1 mm. The gap at the second end 24 of the functional section as measured by the distance of first surface 12 of the first utensil to the second surface 14 of the adjacent utensils in the stack of utensils 120 can be less than 1 cm, less than 0.5 cm, less than 0.4 cm, less than 0.3 cm, less than 0.2 cm, less than 0.1 cm, less than 1 mm, less than 0.5 mm, less than 0.4 mm, less than 0.3 mm, less than 0.2 mm, less than 0.1 mm. The gap at the first end of the handle 32 between every utensil 10 in a stack of utensils 120 can be substantially the same. The gap at the second end 24 of the functional section between every utensil 10 in a stack of utensils 120 can be substantially the same. Reducing the gap between the utensils 10 in a stack of utensils 120 can reduce the height of the stack of utensils 120. The stack of utensils 120 can be loaded into a dispenser with the first surface 12 facing down or with the second surface 14 facing down. The height of the stack of utensils in centimeters as measured by the distance from first surface 12 of the top utensil in a stack of utensils 120 at the first end of the handle 32 of to the second surface 14 of the bottom utensil in the stack of utensils 120 at the first end of the handle 32 of can be less than 100.1%, less than 100.5%, less than 101%, less than 102%, less than 103%, less than 104%, less than 105%, between 100% and 105%, between 100% and 104%, between 100% and 103%, between 100% and 102%, between 100% and 101%, between 100% and 100.5%, between 100.5% and 105%, between 100.5% and 104%, between 100.5% and 103%, between 100.5% and 102%, or between 100.5% and 101% of the height of the utensil 10 in centimeters as measured by the distance from the first surface 12 to the second surface 14 at the first end of the handle 32 multiplied by the number of utensils 10 in the stack of utensils 120.

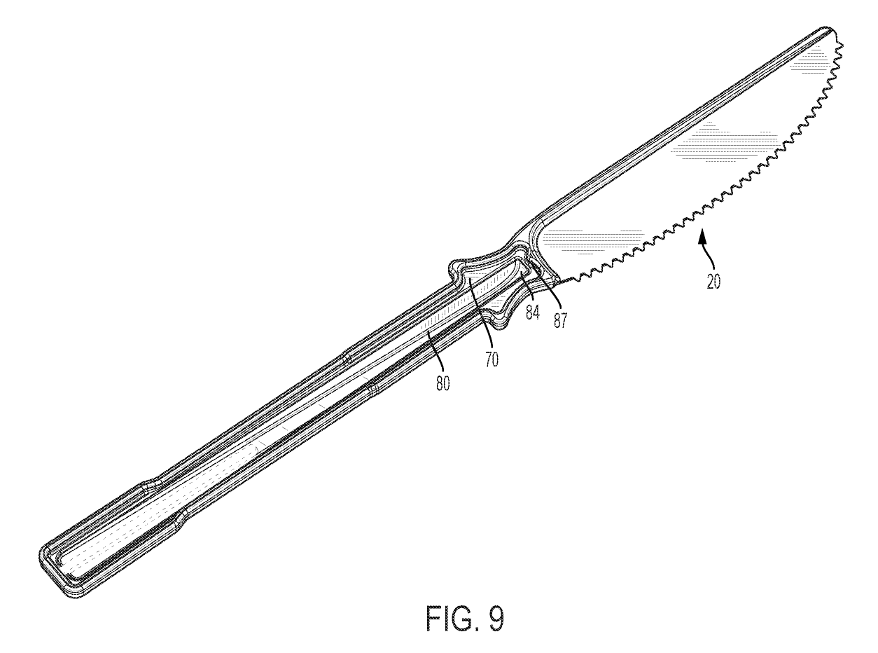

When the utensils 10 are stacked in a stack of utensils 120, an individual utensil 10 in the stack of utensils 120 can generally only slide out of the stack of utensils 120 in one direction. When the utensils 10 are stacked in a stack of utensils 120, an individual utensil 10 in the stack of utensils 120 can generally only slide out in the direction from the handle 30 toward the functional section 20, from the functional section 20 toward the handle 30, or from both the direction from the handle 30 toward the functional section 20 and from the direction from the functional section 20 toward the handle 30. When the stack of utensils 120 are loaded into a dispenser with the first surface 12 facing down, the utensils 10 can generally only slide in the direction from the handle 30 toward the functional section 20. The spine crown 46 can act as a wedge to prevent or otherwise restrict a utensil 10 that is directly below a utensil 10 in the stack of utensils 120 from sliding out toward the handle end 32. The stop 46 can be disposed on the raised spine 46 proximate to the spine crown 46. The stop 48 can prevent or otherwise restrict a utensil 10 that is directly below a utensil 10 in the stack of utensils 120 from sliding out from the handle 30 toward the functional section 20 or from the functional section 20 toward the handle 30. When the stack of utensils 120 are loaded into a dispenser with the first surface 12 facing down, the stop 48 can prevent or otherwise restrict a utensil 10 that is directly below a utensil 10 in the stack of utensils 120 from sliding out from the functional section 20 toward the handle 30. Each utensil can further include a second stop or engagement designed to maintain clearance between any two utensils in a stack. For example, the second stop or engagement of a spoon utensil 10 can be created by the substantially flat surface that defines the second end 84 of the second recessed channel 80, as best shown in FIG. 5. The second stop or engagement of a fork utensil 10 can be created by a middle rib 21 on the underside of the functional section 20 of the fork, as best shown in FIG. 6 adjacent the second end 84 of the second recessed channel 80. The second stop or engagement of a knife utensil 10 can created by a knob, nipple or other detent 87 located within the first recessed channel 70, adjacent the functional section 20, as best seen in FIG. 9.

Embodiments of the present disclosure further relate to any one or more of the following paragraphs:

A cutlery utensil comprising a functional section and a handle comprising: a raised spine disposed on a first surface of the handle and having a height that varies from a first end of the handle in the direction of the functional section, and at least one recessed channel formed in a second surface of the utensil, the second surface of the utensil being opposite the first surface of the utensil, wherein the recessed channel has a depth that varies from the first end of the handle in the direction of the functional section.

A cutlery utensil comprising a functional section, and a handle comprising: a raised spine disposed on a first surface of the handle having a height that increases from a first end of the raised spine to a second end of the raised spine in the direction of the functional section, and a first recessed channel formed in a second surface of the handle, the first surface being opposite the second surface, and a second recessed surface formed within the first recessed channel, wherein the recessed channels are configured to receive a raised spine of a second utensil.

A cutlery utensil comprising: a functional section having at least one detent extending laterally from a side thereof; and a handle comprising: a raised spine disposed on a first surface of the handle having a height that increases from a first end of the raised spine to a second end of the raised spine in the direction of the functional section, and a first recessed channel formed in a second surface of the handle, the first surface being opposite the second surface, and a second recessed surface formed within the first recessed channel, wherein the recessed channels are configured to receive a raised spine of a second utensil.

The cutlery utensil according to any one or more of the preceding paragraphs, further comprising at least one shaped extension extending laterally from one side of the handle.

The cutlery utensil according to any one or more of the preceding paragraphs, wherein a first end of the functional section is adjacent the handle.

The cutlery utensil according to any one or more of the preceding paragraphs, wherein the height of the raised spine is greatest proximate a first end of the functional section.

The cutlery utensil according to any one or more of the preceding paragraphs, wherein the height of the raised spine is least near the first end of the handle.

The cutlery utensil according to any one or more of the preceding paragraphs, wherein the shaped extension is disposed proximate the highest point of the raised spine.

The cutlery utensil according to any one or more of the preceding paragraphs, wherein the at least one shaped extension is triangular in shape.

The cutlery utensil according to any one or more of the preceding paragraphs, further comprising a first shaped extension laterally extending from a first lateral side of the handle, and a second shaped extension laterally extending from an opposite, second lateral side of the handle.

The cutlery utensil according to any one or more of the preceding paragraphs, wherein the shaped extensions are co-planar.

The cutlery utensil according to any one or more of the preceding paragraphs, wherein the functional section has an end, furthest from the handle, that has a serrated edge, forked tines, or a scoop.

The cutlery utensil according to any one or more of the preceding paragraphs, wherein the first section of the raised spine has a length of at least 4 cm.

The cutlery utensil according to any one or more of the preceding paragraphs, wherein the raised spine has a maximum height of at least 0.3 cm.

The cutlery utensil according to any one or more of the preceding paragraphs, wherein the raised spine has a width that decreases from the first end of the handle toward the functional section.

The cutlery utensil according to any one or more of the preceding paragraphs, wherein the first section of the raised spine has a length of at least 2 cm.

The cutlery utensil according to any one or more of the preceding paragraphs, wherein the raised spine has a varying width along a first section of the raised spine that decreases in the direction of the functional section.

The cutlery utensil according to any one or more of the preceding paragraphs, wherein the height of the raised spine is greatest proximate the functional section.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A cutlery utensil comprising:
a functional section; and
a handle comprising:
a raised spine disposed on a first surface of the handle and having a height that varies from a first end of the handle in the direction of the functional section, and
at least one recessed channel formed in a second surface of the utensil, the second surface of the utensil being opposite the first surface of the utensil, wherein the recessed channel has a depth that varies from the first end of the handle in the direction of the functional section.

2. The cutlery utensil of claim 1, further comprising at least one shaped extension extending laterally from one side of the handle.

3. The cutlery utensil of claim 1, wherein a first end of the functional section is adjacent the handle.

4. The cutlery utensil of claim 1, wherein the height of the raised spine is greatest proximate a first end of the functional section.

5. The cutlery utensil of claim 1, wherein the height of the raised spine is least near the first end of the handle.

6. The cutlery utensil of claim 2, wherein the shaped extension is disposed proximate the highest point of the raised spine.

7. The cutlery utensil of claim 2, wherein the at least one shaped extension is triangular in shape.

8. The cutlery utensil of claim 1, further comprising a first shaped extension laterally extending from a first lateral side of the handle, and a second shaped extension laterally extending from an opposite, second lateral side of the handle.

9. The cutlery utensil of claim 8, wherein the shaped extensions are co-planar.

10. The cutlery utensil of claim 1, wherein the functional section has an end, furthest from the handle, that has a serrated edge, forked tines, or a scoop.

11. The cutlery utensil of claim 1, wherein the first section of the raised spine has a length of at least 4 cm.

12. The cutlery utensil of claim 11, wherein the raised spine has a maximum height of at least 0.3 cm.

13. The cutlery utensil of claim 1, wherein the raised spine has a width that decreases from the first end of the handle toward the functional section.

14. A cutlery utensil comprising:
a functional section; and
a handle comprising:
a raised spine disposed on a first surface of the handle having a height that increases from a first end of the raised spine to a second end of the raised spine in the direction of the functional section,
a first recessed channel formed in a second surface of the handle, the first surface being opposite the second surface, and
a second recessed surface formed within the first recessed channel, wherein the recessed channels are configured to receive a raised spine of a second utensil.

15. The cutlery utensil of claim 14, further comprising at least one shaped extension extending laterally from a side of the functional section.

16. The cutlery utensil of claim 14, wherein the first section of the raised spine has a length of at least 2 cm.

17. The cutlery utensil of claim 1, wherein the raised spine has a varying width along a first section of the raised spine that decreases in the direction of the functional section.

18. A cutlery utensil comprising:
a functional section having at least one detent extending laterally from a side thereof; and
a handle comprising:
a raised spine disposed on a first surface of the handle having a height that increases from a first end of the raised spine to a second end of the raised spine in the direction of the functional section,
a first recessed channel formed in a second surface of the handle, the first surface being opposite the second surface, and
a second recessed surface formed within the first recessed channel, wherein the recessed channels are configured to receive a raised spine of a second utensil.

19. The cutlery utensil of claim 18, wherein the height of the raised spine is greatest proximate the functional section.

20. The cutlery utensil of claim 18, wherein the first section of the raised spine has a length of at least 2 cm.
